(19) United States
(12) Patent Application Publication
(10) Pub. No.: US 2011/0226218 A1
(43) Pub. Date: Sep. 22, 2011

(54) Secondary Fuel Premixing Controller for an Air Intake Manifold of a Combustion Engine

(76) Inventors: Supoj Vongsateanchai, Bangkok (TH); Cholathorn Rakdee, Bangkok (TH); Wisoth Vinaisompan, Bangkok (TH); Nitnipa Seanglum, Bangkok (TH)

(21) Appl. No.: 13/049,449

(22) Filed: Mar. 16, 2011

Related U.S. Application Data
(60) Provisional application No. 61/314,298, filed on Mar. 16, 2010.

(51) Int. Cl. F02M 25/07

(52) U.S. Cl. 123/437

(57) ABSTRACT

A secondary fuel premixing controller for introducing a secondary fuel into an air intake manifold of a primary fuel combustion engine. The controller includes a hollow housing having an air inlet, a main controller body, and an air/secondary fuel mixing outlet connected together in central alignment one to another. The air inlet introduces incoming air into the controller while the air/fuel mixing outlet discharges a blended mixture of secondary fuel and air into an air intake manifold of the running engine. The main controller body includes a secondary fuel manifold positioned centrally within an interior of the controller which supports for axial movement an air pressure valve positioned proximate to the air inlet and a secondary fuel/air blender connected thereto. The secondary fuel manifold also has a secondary fuel inlet formed therethrough connectable at an outer end thereof to a source of secondary fuel, an inner end positioned for sealing engagement with the secondary fuel/air blender. The air pressure valve and secondary fuel/air blender are biased to close and seal the inner end of secondary fuel inlet when the engine is stopped and to open the inner end responsive to engine intake air intake through the controller when the engine is running.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to devices and apparatus for improving the fuel efficiency of an internal combustion engine, and more particularly to a secondary fuel controller which selectively introduces alternate fuels such as natural gas (NGV), liquefied petroleum (LPG), and hydrogen (HYDROGEN) into the air intake system of a combustion engine of a vehicle.

2. Description of Related Art

Single fuel systems which operate on well-known fuels such as gasoline, NGV, LPG, HYDROGEN, biofuels, and diesel fuel are somewhat limited in the efficiency capability that can be achieved operating on such single fuels. However, many improvements in the fuel/air intake system for internal combustion engine-powered vehicles have been developed to stretch the efficiency envelope of such single fuel engines.

Previous attempts to use a secondary fuel in order to reduce fuel consumption and greenhouse gases of the primary fuel are well documented. However, common problems in conventional mixers for diesel dual fuel (diesel and LPG fuels) (DDF) results in a loss of engine performance, as well as untimely combustion leading to either early combustion known as “knocking” or to no combustion whatsoever. Moreover, previous inventions do not allow for the reduction of the primary fuel consumption to the degree that the present invention achieves. The uniqueness of the present invention not only resides in the mixing of a secondary fuel into the air intake manifold of the engine, but also provides a controller that is used to control the dosage or amount of flow of the secondary fuel into the air intake manifold.

The foregoing examples of the related art and limitations related therewith are intended to be illustrative and not exclusive. Other limitations of the related art will become apparent to those skilled in the art upon a reading of the specification and a study of the drawings.

### BRIEF SUMMARY OF THE INVENTION

This invention is directed to a controller for mixing of a combustible gas or gas mixture including natural gas (CNG), propane, butane, LPG, hydrogen and octane to be used as a secondary fuel mixed fed into the air intake manifold of an internal combustion engine utilized in vehicles such as generators, ships, cranes, airplanes, and helicopters in order to reduce the fuel consumption of the primary fuel which may include octane, diesel, ethanol and kerosene. Mixing of the secondary fuel in gaseous state within the controller with incoming air before being fed into the air intake manifold of the engine is then mixed with the primary fuel within the engine intake manifold just prior to the fuel mixture reaching the combustion chamber(s). Thus the objective of this invention is to reduce the consumption of the primary fuel by using the secondary fuel without significant loss of engine power and performance.

It is therefore an object of this invention to provide a device for the introduction of a secondary fuel for improving the overall efficiency of an internal combustion engine which normally operates only on a primary fuel.

It is another object of this invention to facilitate operation of an internal combustion engine on a primary fuel with the introduction of a secondary fuel being mixed with a primary fuel in the fuel intake system of the engine without substantial loss of power or engine performance.

Yet another object of this invention is to enhance the overall efficiency and operation of an internal combustion engine normally operated only on one primary fuel by the introduction of a controller which mixes a secondary fuel with the primary fuel within the air intake manifold of the engine.

The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements. In addition to the exemplary aspects and embodiments described above, further aspects and embodiments will become apparent by reference to the drawings and by study of the following descriptions.

### BRIEF DESCRIPTION OF THE SEVERAL VIEWS OF THE DRAWING(S)

FIG. 1 is a perspective view of the invention.

FIG. 2 is an exploded perspective view of FIG. 1.

FIG. 3 is a top plan view of FIG. 1.

FIG. 4 is a side elevation view of FIG. 1.

FIG. 5 is an end elevation view of FIG. 1.

FIG. 6 is a view in the direction of arrows 6-6 in FIG. 2.

FIG. 7 is a longitudinal section view of FIG. 1 absent the spring mechanism for clarify.

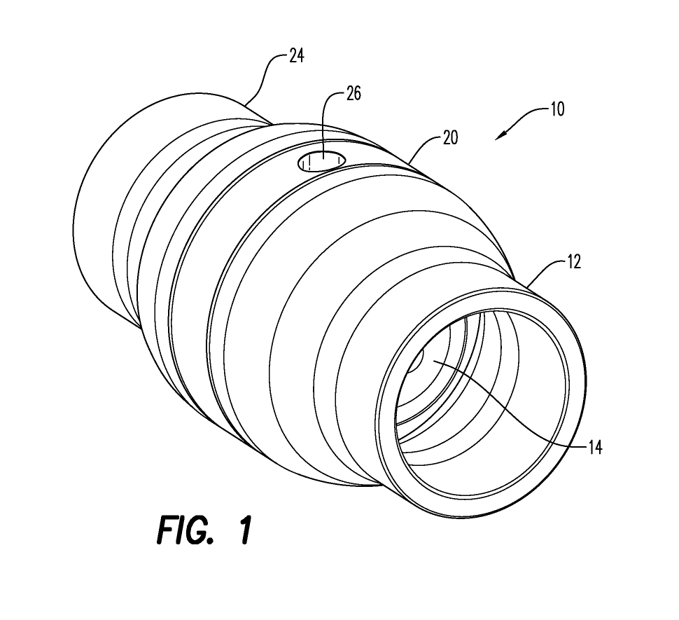

Exemplary embodiments are illustrated in reference figures of the drawings. It is intended that the embodiments and figures disclosed herein are to be considered to be illustrative rather than limiting.

### DETAILED DESCRIPTION OF THE INVENTION

### Nomenclature

10 controller

12 air inlet

14 air pressure valve

16 connector screw

18 airflow resistance spring

20 main controller body

22 secondary fuel/air blender

24 air/fuel mixing outlet

26 secondary fuel inlet

28 secondary fuel manifold

A inlet airflow

B valve/blender movement

C secondary fuel inlet airflow

D secondary fuel flow through manifold

E & F blended outlet flow of secondary fuel and air

Referring now to the drawings, the secondary fuel controller is shown generally at numeral 10 and includes a hollow air inlet 12 threadably engaged with a hollow main controller body 20 at one end thereof, and threadably engaged with an air/fuel mixing outlet 24. The air inlet 12 and the air fuel mixing outlet 24 are preferably formed of molded plastic material, while the main controller body is preferably formed of machined or molded aluminum for added strength. However, alternate materials of a suitable physical properties nature may be substituted therefor.

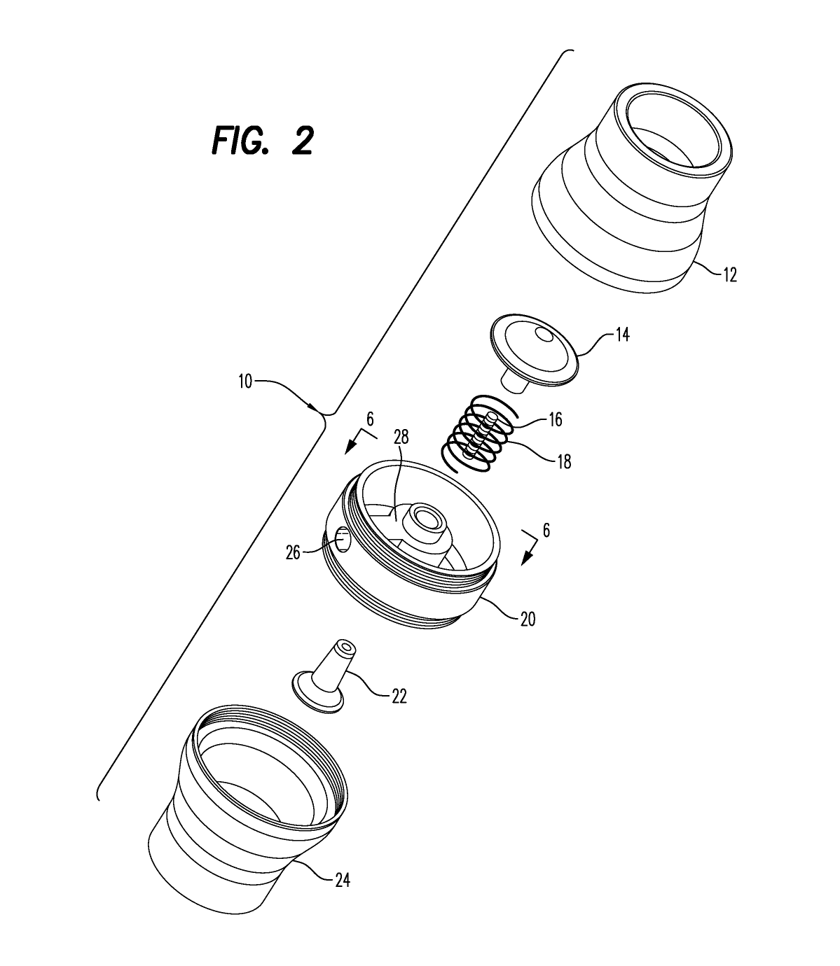

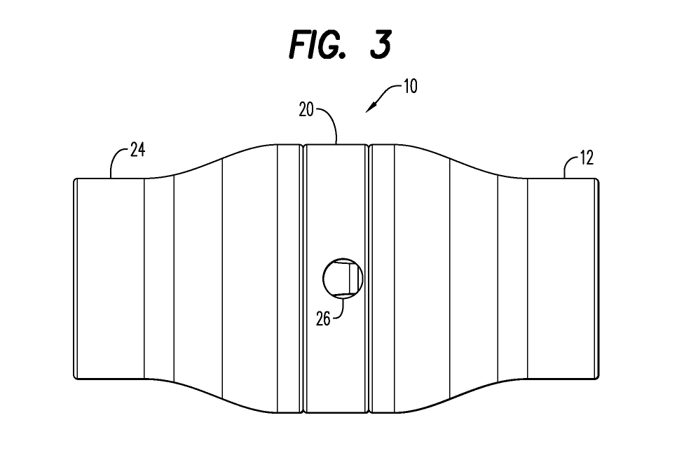

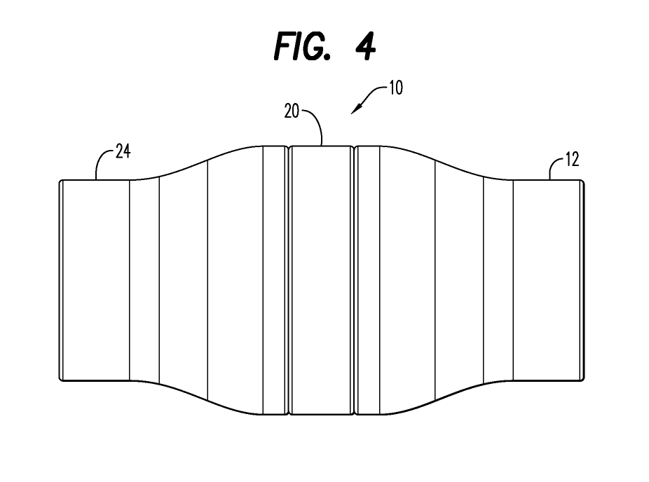

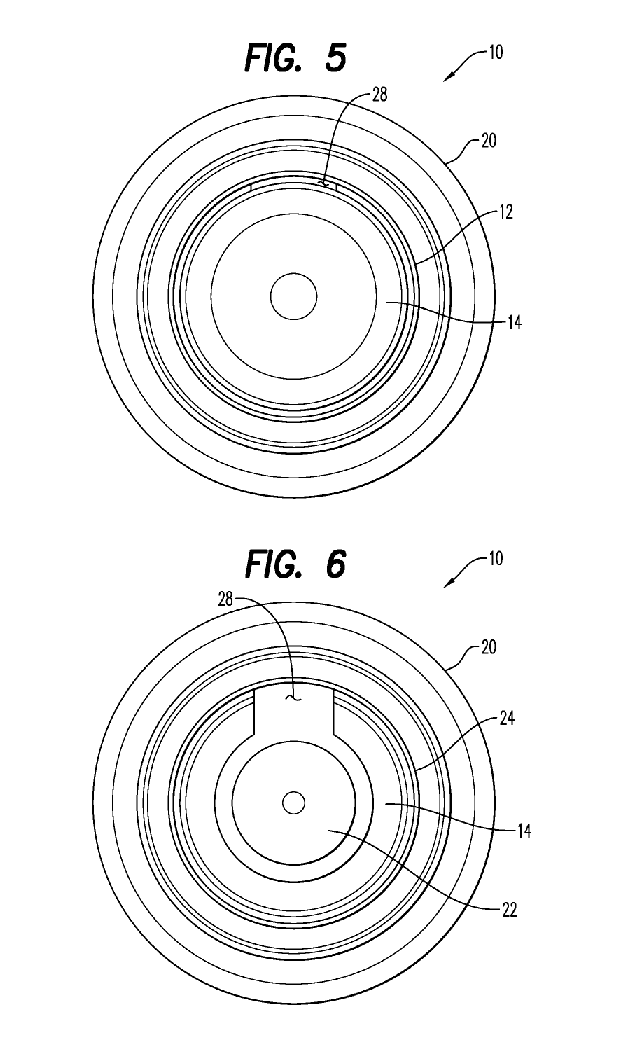

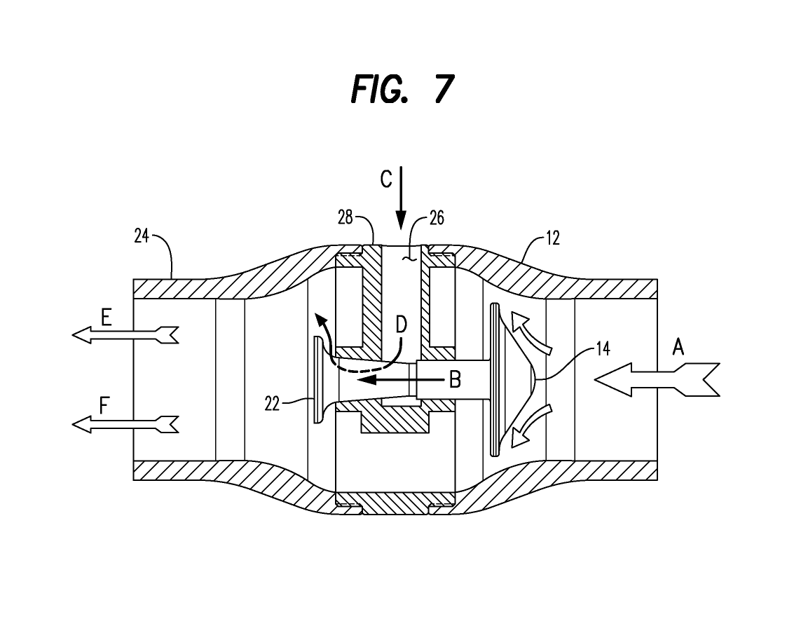

Referring to FIG. 2, within the controller 10 are mounted coaxially aligned air pressure valve 14 positioned in proximity to the inlet end of the air inlet 12, and a secondary fuel air/air blender 22 positioned in proximity to the outlet end of air/fuel mixing outlet 24. The valve 14 and air blender 22 are held together by a coaxially aligned connector screw 16 so that, as best seen in FIG. 7, the valve 14 and air blender 22 move in unison in the direction of arrow B as a unit within a secondary fuel manifold 28 formed interiorly of the main controller body 20. An airflow resistance spring 18 is positioned between the air pressure valve 14 and the secondary fuel manifold 28 so as to maintain this arrangement in a closed position wherein, the air blender 22 is seated against an outlet port of the secondary fuel manifold 28.

The secondary fuel manifold 28 includes a transversely oriented secondary fuel inlet 26 which is connectable to a source of secondary fuel such as natural gas (NGV), liquefied petroleum (LPG) and hydrogen (HYDROGEN). Other fuel sources such as ethanol, biofuel and the like are also envisioned within the scope of this invention. When so connected to the secondary fuel source, pressurized fuel is available within the secondary fuel inlet 26 but will only flow in the direction of arrow D when the air blender 22 is moved in the direction of arrow B to a variable opened position. Opening of the air blender 22 is controlled by inlet air flowing into the air inlet 12 in the direction of arrow A striking against the convex contoured surface of the air pressure valve 14. The greater the air flow in the direction of arrow A as regulated by engine demand, the greater the opening of the air blender 22.

The secondary or alternate fuel source which enters into the interior of the controller 10 through secondary fuel inlet 26 in the direction of arrow C and then past the air blender 22 in the direction of arrow D will mix within the outlet 24 with the incoming air for discharge from the outlet 24 in the direction of arrows E and F in a mixed or blended gaseous relationship. This mixed air/secondary fuel mixture will then flow into an air intake manifold (not shown) of an internal combustion engine for proper blending with the primary fuel source being fed separately into the air intake manifold of the engine (again, not shown).

The controller 10 thus controls the amount of secondary fuel which is premixed within the interior of the controller 10 in proportion to the amount of inlet air moving into the controller in the direction of arrow A in FIG. 7. The strength of the air flow resistance spring 18, in combination with the adjusted effective length of the connector screw 16, will determine the ease with which the inlet air flow striking against and flowing around the air pressure valve 14 and the maximum distance that the air pressure valve 14 can travel longitudinally in the direction of arrow B to modulate the amount of secondary fuel flowing into the interior of the controller 10.

While a number of exemplary aspects and embodiments have been discussed above, those of skill in the art will recognize certain modifications, permutations and additions and subcombinations thereof. It is therefore intended that the following appended claims and claims hereinafter introduced are interpreted to include all such modifications, permutations, additions and subcombinations that are within their true spirit and scope.

1. A secondary fuel premixing controller for introducing a secondary fuel into an air intake manifold of a primary fuel combustion engine comprising:
a hollow housing having an air inlet, a main controller body, and an air/secondary fuel mixing outlet connected together in coaxial alignment one to another;
said air inlet introducing air into said controller, said air/fuel mixing outlet discharging a blended mixture of secondary fuel and air into an air intake manifold of the engine;
said main controller body including a secondary fuel manifold positioned centrally within an interior of said controller and supporting for axial movement within the interior an air pressure valve positioned proximate to said air inlet connected coaxially to a secondary fuel/air blender;
said secondary fuel manifold also having a secondary fuel inlet formed therethrough connectable at an outer end thereof to a source of secondary fuel, an inner end of said secondary fuel inlet positioned for sealing engagement with said secondary fuel/air blender;
said air pressure valve and said secondary fuel/air blender being cooperatively configured and biased to close and seal the inner end of said secondary fuel inlet when the engine is stopped and to open said inner end responsive to engine intake air intake through said controller when the engine is running.

2. A method of introducing a secondary fuel into an intake manifold of a combustion engine which normally operates on a primary fuel source comprising the steps of:
a. providing a secondary fuel premixing controller into an inlet air stream of a combustion engine, said controller including:
a hollow housing having an air inlet, a main controller body, and an air/secondary fuel mixing outlet connected together in coaxial alignment one to another;
said air inlet receiving air into said controller responsive to operation of the engine, said air/fuel mixing outlet discharging a blended mixture of secondary fuel and air into an air intake manifold of the engine;
said main controller body including a secondary fuel manifold positioned centrally within an interior of said controller and supporting for axial movement an air pressure valve positioned proximate to said air inlet and being connected coaxially to a secondary fuel/air blender;
said secondary fuel manifold also having a secondary fuel inlet formed therethrough connectable at an outer end thereof to a source of secondary fuel, an inner end of said secondary fuel inlet positioned for sealing engagement with said secondary fuel/air blender;
said air pressure valve and said secondary fuel/air blender being cooperatively configured and biased to close and seal the inner end of said secondary fuel inlet when the engine is stopped and to open said inner end responsive to engine intake air intake through said controller when the engine is running.
b. connecting said secondary fuel inlet to a secondary fuel source;
c. operating the engine.
